(19) United States
(12) Patent Application Publication
(10) Pub. No.: US 2004/0242095 A1
(43) Pub. Date: Dec. 2, 2004

(54) Composites reinforced by wire net or mesh for lightweight, strength and stiffness

(76) Inventor: Amit Prakash, Hudson, OH (US)

Correspondence Address: AMIT PRAKASH, 105 KESWICK DR., HUDSON, OH, 44236, US

(21) Appl. No.: 10/444,363

(22) Filed: May 27, 2003

(51) Int. Cl. B32B 27/04; B32B 15/08; B32B 15/01

(52) U.S. Cl. 442/19; 442/6; 442/7

(57) ABSTRACT

A composite material having a polymer or a metal matrix is proposed where reinforcement is achieved by one or more of a net or a mesh or a screen structure. Openings in the net structure facilitates good mechanical bond with matrix. High strength and high modulus wires, preferably steel wires can be used to make the net structure. Nets can be placed at a desired plane with respect to the neutral axis of the structure to optimize bending and other properties. In a 5.6 mm thick polyester resin based matrix, placing steel wire nets at approximately 1 mm under each sides, increased bending stiffness by a factor of 2, while increasing density from 1.3 to 1.5

### REFERENCES CITED

| | | | |
|---|---|---|---|
| 5,908.685 | June 1999 | Prakash et al. | 428/212 |
| 6,546,694B2 | April 2003 | Clifford | 52/791.1 |
| 3,900,627 | August 1975 | Angioletti et al. | 428/114 |
| 3,607,592 | September 1971 | Jenkins et al. | 161/57 |
| 6,533,977B1 | March 2003 | Zettel et al. | 264/110 |
| 5,856,243 | January 1999 | Geirhos et al. | 442/57 |
| 5,337,693 | August 1994 | Ross et al. | 114/69 |
| 6,263,721 | July 2001 | He | 138/174 |

### BACKGROUND OF THE INVENTION

Composite materials are used for their stiffness and strength. They constitute of at least two components commonly known as matrix and reinforcing materials. Reinforcing components usually are in the form of plates, fibers or particles. Fiber reinforced composites utilize either random or oriented fine fibers. Common reinforcing fibers are polyester, rayon, fiberglass, carbon, nylon, silicon carbide, wire etc. The matrix material can be a polymer, metal or ceramic.

Most composites require a good chemical bond between the matrix and the reinforcing components for an efficient stress transfer at the interface. A compatible fabric coating and/or suitable cement property of the matrix is required to achieve a good chemical bond.

This patent will utilize the advantage of a predominantly mechanical bond between the reinforcing wire network and the matrix. A net or mesh structure made of long and generally straight fibers to reinforce a matrix of plastic, rubber or metal has been proposed. The matrix material can mechanically grip a mesh structure more effectively by using its openings. A mechanical bond may last much longer than chemical bonds. Additionally the direction of fibers in the net can be calculated to optimize the reinforcing needs.

In the current document words fiber, wire and cord have comparable meaning and one can replace the other. The same applies to words mesh, net and screen, which are comparable structures.

Referring to prior knowledge, U.S. Pat. No. 5,908,685 proposes that continuous fibers of different modulus placed on different layers can develop direction dependence stiffness in the composite. U.S. Pat. No. 6,546,694 B titled ‘light weight structural panel’ proposed a sandwich construction comprising of high modulus material plates bonded on either sides of a low modulus matrix. Tires, conveyor belts and similar structures use continuous fibers of metal or non-metal to obtain desired stiffness and strength as for example, discussed in U.S. Pat. No. 3,900,627. U.S. Pat. No. 3,607,592 proposes multiple plies of wires sandwiching a textile ply in rubber matrix to gain overall stiffness in the structure. Above and other references take advantage of reinforcing a soft matrix by rigid components which is attached by a chemical bond and do not point to a network of fibers in one plane. U.S. Pat. No. 6,533,977 B1, however, shows a wire mesh as a starting material for washers etc. but its technical merit and details are not outlined. U.S. Pat. No. 5,856,243 proposes a net of hybrid yarn with low melting bonding yarn to make roofing membranes. Here the reinforcement is based on developing a chemical bonding between the fiber and the matrix. U.S. Pat. No. 5,337,693 proposes new concepts of internal liners for oil tankers and claim 4 suggests a net structure made of any of the common fibers to develop a flexible liner.

Woven textiles made of fiberglass or silicon carbide or carbon fibers in conjunction with an adhesive cement matrix are commonly used to make or repair structures. In such cases, due to lower rigidity of the fabric and other natures of the fibers such as off axis ductility etc., total strength gained by the composite is a lower percent of the total original fiber strength. In the present concept, a net type structure having substantially straight wire network with periodic openings have been utilized to reinforce a matrix. The net structure allows significant mechanical bonding between the fibers and the matrix, easy in manufacturing the composite and provides a significantly higher percentage of strength return with respect to total individual wire strength.

### BRIEF SUMMARY

Proposed technology enhances properties of a composite material by using wires which are: A) generally straight: for higher mechanical efficiency, B) relatively larger in diameter: for improved compressive behavior, C) higher modulus than matrix: for carrying more stress, D) metallic: for higher modulus and temperature stability and E) in the form of a net structure: for (a) improved mechanical bonding with the matrix, (b) to provide appropriate directional reinforcement and (c) in case of bending, keeping all fibers on the same nominal distance from the neutral axis providing desired stiffness. To gain on stress carrying capacity, high strength fibers are needed. Very high strength wire will provide a very efficient and inexpensive composite. Multiple wire nets stacked parallel and touching or close to each other will improve shear properties.

### DETAILED DESCRIPTION OF THE DRAWING

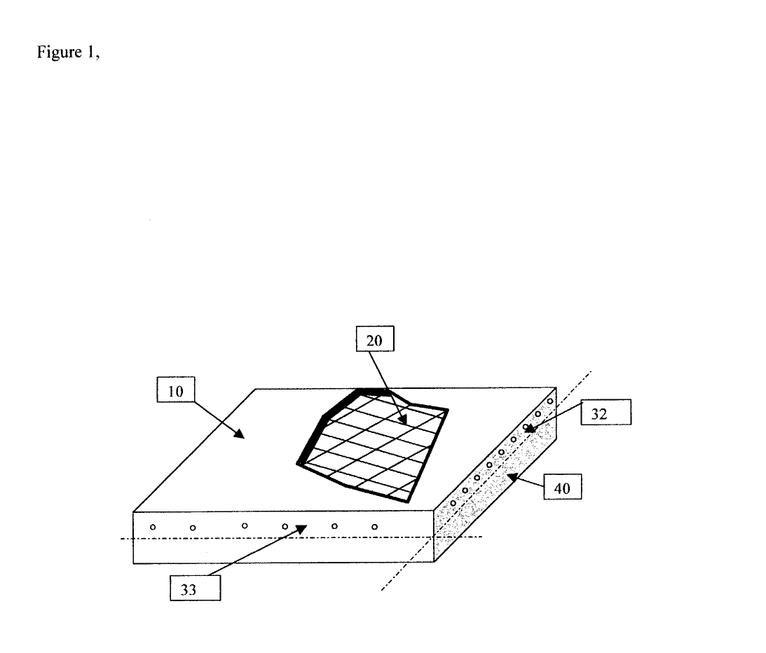

FIG. 1: a composite, 10, having only one layer of a wire net, 20, and placed away from the mid axis. Net structure facilitates mechanical bond with matrix 40. All wires, 32 and 33, of one net, are generally on the same plane, therefore will contribute maximum to bending stresses.

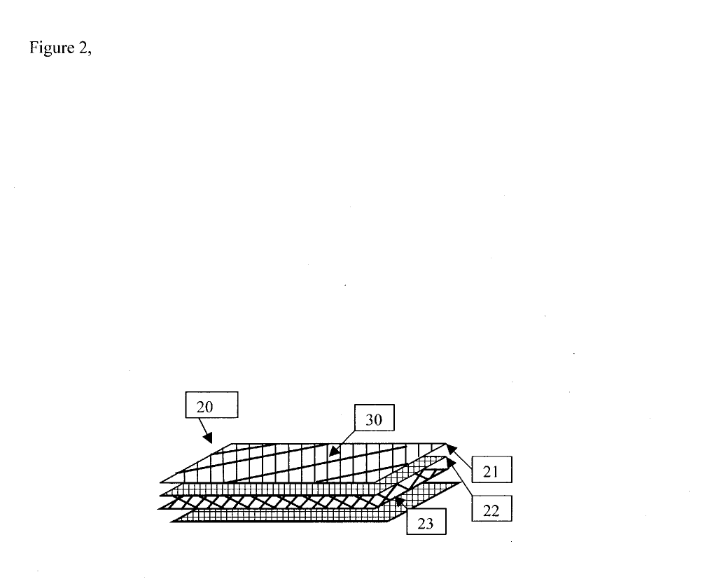

FIG. 2: A stack of multiple nets, 21, 22, 23 of different wire types are used to reinforcing a composite. Wire network 30 of net 20, is oriented as per calculated need.

### DETAILED DESCRIPTION OF THE INVENTION

A composite material is proposed which uses a net or mesh structure made of long and generally straight fibers to reinforce a matrix of plastic, rubber or metal. The matrix can grip the net structure by mechanical interlocking by using its openings. Therefore the requirement of a chemical bond if not eliminated, is at least substantially reduced. Additionally the direction of wires in the net can be calculated to optimize the reinforcing needs. Alignment of wires controls the mechanical properties of the composite. Straight wires will contribute more to hold stresses parallel to fiber axis. In such applications, a net made of continuous wires, and woven in a tight manner to yield higher longitudinal strength is preferred. Very high strength wires, for example, high carbon, alloy steel wire, having strength in excess of 3000 MPa (435 KSI) of 0.2 to 0.4 mm diameters can be used to make a net structure with proper openings. If more strength is required, cords having multiple wires can also be used to make a net. Alternately wires can be welded at their intersections. These are common practices in manufacturing wire cloth or mesh. If welding operation is performed, a heat treatment may be needed to either stress relieve or to reach the desired strength/toughness level.

The mesh comprises of cords running along two or more axes at desired angles on the plane of the mesh. There should be substantial opening between the wires or group of wires to allow adequate penetration of the matrix material through it. While wire can provide higher strength compared to a plate made of the same material, a thin plate with proper opening network can also be used. The net structure is then placed in a matrix having modulus lower than the wire. One or more of the net layers can be placed depending upon the application load condition. Placing nets in contact with each other will help improve the shear property. The placement of net can be done by any standard practice such as pouring liquid polymer or metal, thermally pressing the nets into the matrix, pre laminating the nets and then chemically or thermally attaching the laminates together.

Following are the results from three point bending test conducted over a 15 cm span. Test piece dimension was: 5.6 mm thick×13.3 cm long×8.9 cm wide. Sample-1 had only a polyester liquid resin with a hardener mix and was allowed to set for 7 days. In Sample-2, the filler matrix was same as Sample-1 plus two wire nets made of steel wires were placed approxiately 1 mm under the top and bottom surfaces of the thickness. The net comprised of 0.56 cm diameter wires, running at 90 degrees axes, at 1.54 square patterns per cm square area density. At intersections wires were rigidly welded. In the three points bend test, the bending stiffness doubled for the net reinforced plate Sample-2

What is claimed is:

1. A composite material structure which comprises at least two material components and where one component is called a matrix and is a polymer or a metal and where the second component is a net structure made of substantially straight wires to preserve higher percentage of original tensile strength, running at multiple coplanar axes and where the net structure has periodic openings due to the arrangement of the wires for the purpose of providing mechanical locking with the matrix material and where the modulus of wires in the net is substantially higher than matrix.

2. The composite of claim 1, where wires in at least one direction are in the form of a cord having a helix angle between 60 to 90 degrees.

3. The composite as claimed in 1, where the reinforcing wires are steel wires of strength in the range of 2000 to 6000 MPa

4. The composite of claim 3, where the individual wire diameter is between 0.1 to 6 mm

5. The composite of claim 1, where the intersecting wires are not rigidly joined

6. The composite of claim 1, where the intersecting wires are rigidly joined

7. The composite as claimed in 1, where the matrix is a reclaimed polymeric material.

8. The composite as claimed in 1, where the matrix is a fiber reinforced polymeric material.

9. A composite as claimed in 1, where the matrix is a metal.

10. A composite as claimed in 1, where the matrix is an alloy of aluminum

11. A composite as claimed in 1, where multiple net structures are stacked parallel to each other

12. The composite of claim 1, where multiple wire nets are stacked in such manner that some or all is in contact to its adjacent net.

13. A composite as claimed in 1, where the wire net structure is attached mechanically to at least one external side of the matrix to gain bending stiffness.

14. A composite as claimed in 1, where the net comprises of wire arrangements to yield different strength in different directions.
